(19) United States
(12) Patent Application Publication
(10) Pub. No.: US 2025/0145516 A1
(43) Pub. Date: May 8, 2025

(54) LOW DIELECTRIC OXIDE GLASS COMPOSITION, GLASS FIBER AND GLASS SUBSTRATE USING THE SAME

(71) Applicant: GIST(Gwangju Institute of Science and Technology), Gwangju (KR)

(72) Inventors: Bok Hyeon KIM, Gwangju (KR); Yeong Wook PARK, Gwangju (KR); Won Tack HAN, Gwangju (KR)

(73) Assignee: GIST(Gwangju Institute of Science and Technology), Gwangju (KR)

(21) Appl. No.: 19/014,550

(22) Filed: Jan. 9, 2025

Related U.S. Application Data
(63) Continuation-in-part of application No. PCT/KR2023/017946, filed on Nov. 9, 2023.

(30) Foreign Application Priority Data
Jun. 26, 2023 (KR) 10-2023-0082016
Jun. 26, 2024 (KR) 10-2024-0083909

(51) Int. Cl. C03C 3/091

(52) U.S. Cl. CPC C03C 3/091; C03C 2213/00

(57) ABSTRACT

The present invention relates to an oxide glass composition having a low dielectric constant and dielectric dissipation factor. The oxide glass composition according to the present invention can provide a glass material for PCBs, glass fibers and glass substrates having a low dielectric constant and dielectric dissipation factor properties. The oxide glass composition according to the present invention has a low softening temperature and excellent clarification characteristics, and thus can solve various problems of existing technologies.

### CROSS-REFERENCE TO RELATED APPLICATIONS

The present application is a continuation of International Patent Application No. PCT/KR2023/017946, filed on Nov. 9, 2023, which claims priority to Korean Patent Applications Nos. 10-2023-0082016, filed Jun. 26, 2023 and 10-2024-0083909, filed Jun. 26, 2024, the entire contents of which are incorporated herein for all purposes by this reference.

### BACKGROUND OF THE INVENTION

### Field of the Invention

The present invention relates to a low dielectric oxide glass composition, and a glass fiber and a glass substrate using same and, more specifically, to a low dielectric oxide glass composition having low dielectric properties, low viscosity and easy removal of microbubbles, and a glass fiber and a glass substrate using same.

### Description of the Related Art

Multilayer printed circuit boards (PCBs) are key components used in the development of high-performance IT devices. With the growth of ultra-high-speed communications, self-driving cars, and artificial intelligence markets, the demand for multilayer PCBs used in the development of high-performance signal processing boards is rapidly increasing.

Copper Clad Laminate (CCL) used in the development of PCBs is largely composed of inorganic materials such as glass fiber, organic materials such as resins, fillers, and copper foils. Glass fibers are used as the skeleton of the prepreg that constitutes a CCL and play an important role in ensuring sufficient mechanical and thermal properties.

In particular, as communication technology has recently become faster and larger in capacity, it is important to secure materials having a low dielectric dissipation factor in the high-frequency signal band for substrate materials (CCL) used in communication equipment, base station radars, antennas, server boards, etc. To this end, it is essential to secure technology for glass fiber materials having low dielectric constant (Dk) and dielectric dissipation factor (Df) characteristics that constitute a CCL.

Conventional E-glass used in low-speed PCBs is made of a glass material having a composition of, for example, 54.3 wt % of SiO₂, 6 wt % of B₂O₃, 14 wt % of Al₂O₃, 22.7 wt % of MgO+CaO, 1.0 wt % of Li₂O+Na₂O+K₂O, and 0.3 wt % of FeO₂. Such E-glass has a high dielectric constant in the range of 6.5 to 7.0 at 1 MHz and a high dielectric dissipation factor in the range of 0.005 to 0.008 and, thus, cannot be easily used in a high-frequency band higher than 1 GHz due to high energy loss.

Therefore, the existing general electronic device glass fiber (E-glass) material has limitations in securing the dielectric properties of a CCL required for ultra-high-speed communication of 5G or higher, and it is necessary to secure a glass material having mechanical and thermal properties similar to those of existing materials but having a lower dielectric constant and dielectric dissipation factor, and glass fiber technology using same. In order to secure the dielectric properties of a CCL required for ultra-high-speed communication of 5G or higher, it is desirable to secure glass material technology having sufficiently a low dielectric constant and dielectric dissipation factor in a high-frequency band of 10 GHz or higher. Recently, ultra-high-speed communication technology of 28 GHz or higher has been commercialized in order to increase data transmission capacity. Therefore, it is necessary to verify and secure low-k glass technology for a glass fiber used in printed circuit boards that has sufficient dielectric properties (dielectric constant, dielectric dissipation factor) and properties in the ultra-high frequency band of tens of GHz or higher, furthermore in the band range of 1 to 10 GHZ.

To date, much research has been conducted on glass compositions having low dielectric properties for use in PCBs, and various types of low-k glass compositions have been proposed. For example, in the case of low-k glass, the glass contains a composition of 60 to 68 wt % of SiO₂, 7 to 12 wt % of B₂O₃, and 9 to 14 wt % of Al₂O₃. Since the glass with such a composition contains a high concentration of SiO₂, the viscosity may increase, which may cause a problem in that it becomes difficult to spin glass fibers. If a high concentration of alkali ions is added to lower the viscosity, the dielectric properties may deteriorate.

Another example is a low-k glass having a composition of 50 to 60 wt % of SiO₂, 15 to 25 wt % of B₂O₃, 10 to 18 wt % of Al₂O₃, and 5 to 12 wt % of CaO+MgO. In the case of glass with such composition, the glass contains a large amount of B₂O₃, various problems such as low resistance to water, generation of many bubbles during the melting process for production of glass, and low mechanical strength may occur, thereby having difficulties in requiring the use of additional additives or the optimization of the composition.

In order to be used as a low-k glass material for a glass fiber used in PCBs, various properties such as dielectric properties, viscosity, microbubble properties, and thermal stability must be secured.

To explain in more detail, in order to be used as a glass fiber material for PCBs, the signal transmission loss must be low. To this end, the dielectric constant and dielectric dissipation factor of the glass material must be sufficiently low. A glass material for a glass fiber used in PCBs generally has a dielectric constant of 4.9 or less and a dielectric dissipation factor of 0.005 or less.

In addition, the low-k glass material used in PCBs must be able to be manufactured from glass fibers having a diameter of several micrometers to several tens of micrometers by a spinning process for producing glass fibers. To this end, the glass must have sufficiently low viscosity and no microbubbles inside.

If the viscosity of the glass is not sufficiently low, the temperature must be increased, which causes problems such as shortening the life of the bushing module made of platinum and difficulty in controlling the diameter and high-speed spinning of glass fibers. In addition, air bubbles (or microbubbles) present in the glass must be easily removed. Air bubbles present in the glass cause glass fibers to break during the spinning process. In the prior art, substances having a clarifying effect such as As₂S₃, Sb₂O₃, and Na₂SO₄ were used to remove air bubbles present in the glass, but, when these substances are used, the dielectric properties of the glass deteriorate or the glass becomes toxic. In addition, the glass must have sufficient thermal stability for smooth glass fiber spinning. If the thermal stability of the glass is low, crystallization (devitrification) occurs in the glass fibers during the spinning process, causing the glass fibers to break or the bushing hole to become clogged, making continuous glass fiber production impossible.

The low-k glass composition can be used not only as a material for glass fibers but also as a material for glass substrates. Recently, PCB technology that is easy to achieve high integration and large area has been demanded. To this end, a fine redistribution layer (RDL) and LS value should be able to be implemented. The glass substrate has the advantages of superior thermal characteristics, less warping, and superior flatness, as compared to CCL-based PCB materials, enabling the production of high-performance PCBs. In order to produce high-performance PCBs, the materials used therein have low viscosity and, thus, should be easily produced in the form of a glass substrate. Therefore, in order to use same as a glass substrate it is necessary to secure a technology for a glass material that has excellent dielectric and thermal characteristics as well as properties that make it easy to be produced in a large area.

In addition, the low-k glass material used in the PCB must be easily manufactured into a glass substrate having excellent flatness and a thickness of several hundred micrometers to several millimeters through a post-processing process. To this end, the glass must have sufficiently low viscosity and no microbubbles inside.

The present invention is characterized by providing a glass material having low dielectric properties and simultaneously having excellent viscosity, microbubble properties and thermal stability, a glass fiber and glass substrate technology, by solving the problems of the prior art.

### SUMMARY OF THE INVENTION

The present invention aims to solve various problems of the prior art. The present invention provides an oxide glass composition having low viscosity of glass to be easily radiated and excellent microbubble characteristics, simultaneously having a low dielectric constant and dielectric dissipation factor, and a glass fiber technology using same. The present invention also provides technology for a glass substrate that can be easily manufactured into a substrate having low viscosity to be thin and have excellent flatness and excellent microbubble characteristics, simultaneously having a low dielectric constant and dielectric dissipation factor.

The objectives of the present invention are not limited to the objectives mentioned above, and other objectives that are not mentioned will be more clearly understood by the following description.

To achieve the objectives, a low-k glass composition according to one embodiment of the present invention comprises silica (SiO₂); boron trioxide (B₂O₃); aluminum oxide (Al₂O₃); and tellurium oxide (TeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may further comprise one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of tellurium oxide (TeO₂).

The low-k glass composition may have a dielectric constant of 4.9 or less and a softening temperature of 810° C. or less.

In addition, a low-k glass composition according to one embodiment of the present invention comprises silica (SiO₂); boron trioxide (B₂O₃); aluminum oxide (Al₂O₃); and germanium oxide (GeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may additionally comprise one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of germanium oxide (GeO₂).

The low-k glass composition may have a dielectric constant of 4.9 or less and a softening temperature of 810° C. or less.

In addition, a low-k glass composition according to one embodiment of the present invention comprises silica (SiO₂); boron trioxide (B₂O₃); aluminum oxide (Al₂O₃); tellurium oxide (TeO₂); and germanium oxide (GeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may further comprise one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), 0.1 to 8.0 mol % of tellurium oxide (TeO₂), and 0.1 to 8.0 mol % of germanium oxide (GeO₂).

The low-k glass composition may have a dielectric constant of 4.9 or less and a softening temperature of 810° C. or less.

In addition, the glass fiber according to one embodiment of the present invention comprises the above-described low-k glass composition.

In addition, a glass substrate according to one embodiment of the present invention comprises the above-described low-k glass composition.

According to the present invention, the glass composition has low viscosity, making it easy to perform a glass fiber spinning process or a glass substrate manufacturing process, has excellent microbubble characteristics, and simultaneously has low dielectric constant and dielectric dissipation factor. The glass composition according to the present invention can be used as a glass fiber or glass substrate for a printed circuit board that requires low dielectric properties, high mechanical strength, and low thermal expansion properties.

### BRIEF DESCRIPTION OF THE DRAWINGS

FIGS. 1A and 1B illustrate the dielectric constant (Dk) and dielectric dissipation factor (Df) characteristics of a glass composition according to a comparative example of the present invention.

FIG. 2A to FIG. 5B illustrate the dielectric constant (Dk) and dielectric dissipation factor (Df) characteristics of a low-k maintaining composition according to an embodiment of the present invention in a band of 10 MHz to 1 GHZ.

FIGS. 6A to 6D illustrate an SEM image of a glass fiber prepared from a low-k glass composition according to an embodiment of the present invention.

FIGS. 7A and 7B illustrate a photographic image of a glass substrate prepared from a low-k glass composition according to an embodiment of the present invention.

### DETAILED DESCRIPTION OF THE PREFERRED EMBODIMENT

Hereinafter, embodiments of the present invention will be described in detail so that those skilled in the art can easily implement the present invention. However, the present invention may be implemented in various different forms and is not limited to the embodiments described herein.

The dielectric properties of glass materials can be explained by the Clausius-Mossotti equation as shown in the following Equation 1:

$$ϵ = \frac{3 {V}_{m} + 8 {πα}^{T}}{3 {V}_{m} − 4 {πα}^{T}} \qquad [ Equation l ]$$

In Equation 1, ϵ, Vₘ, and α^{T} represent the dielectric constant (Dk), molar volume, and total polarizability, respectively. In addition, the molar volume given in Equation 1 is given as a function determined by the molar mass (MW), density (ρ), and Avogadro's number (N_{A}), as shown in the following Equation 2:

$${V}_{m} = \frac{MW}{ρ {N}_{A}} \qquad [ Equation 2 ]$$

Therefore, according to Equation 1, the dielectric constant is given as a function of molar volume and total polarizability. In general, as the molar volume increases and the total polarizability decreases, the dielectric constant decreases. Since the molar volume is again given as a function of molar mass and density, when a specific component is added to the glass, the total polarizability, molar volume, molar mass, and density are affected simultaneously. Therefore, the dielectric constant is affected by complex factors.

In a glass material, polarizability greatly affects the dielectric properties and is given by the sum of electronic polarization, ionic polarization, dipolar polarization, orientational polarization, interfacial polarization, and space charge polarization. In addition, the type of polarization that affects the polarizability varies depending on the frequency band.

When the frequency range is the band of THz (1012 to 1015 Hz), the dielectric properties are determined by electronic polarization. On the other hand, in the frequency range of the bands of MHz and GHZ (106 to 1012 Hz) used for communication, the dielectric properties are determined by electronic polarization and ionic polarization. Therefore, the glass material may have different properties depending on the frequency band, and it is necessary to design and optimize the glass composition suitable for the frequency band. In addition, the ionic polarization is given by the sum of cation polarization and anion polarization, and the oxide glass compositions is greatly affected by oxygen ion polarization. Therefore, when designing a low-k glass composition, it is necessary to consider the combined effects and analyze the characteristics.

A low-k glass composition according to one embodiment of the present invention comprises silica (SiO₂); boron trioxide (B₂O₃); aluminum oxide (Al₂O₃); and tellurium oxide (TeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may further comprise one or two or more selected from the group consisting of phosphorus pentoxide (P₂O₅), titanium oxide (TiO₂), and fluorine (F₂).

The low-k glass composition may further comprise zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of tellurium oxide (TeO₂).

The low-k glass composition may have a dielectric constant of 4.9 or less and a softening temperature of 810° C. or less.

In addition, a low-k glass composition according to one embodiment of the present invention comprises silica (SiO₂); boron trioxide (B₂O₃); aluminum oxide (Al₂O₃); and germanium oxide (GeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may further comprise one or two or more selected from the group consisting of phosphorus pentoxide (P₂O₅), titanium oxide (TiO₂), and fluorine (F₂).

The low-k glass composition may further comprise zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of germanium oxide (GeO₂).

The low-k glass composition may have a dielectric constant of 4.9 or less and a softening temperature of 810° C. or less.

In addition, a low-k glass composition according to one embodiment of the present invention comprises silica (SiO₂); boron trioxide (B₂O₃); aluminum oxide (Al₂O₃); tellurium oxide (TeO₂); and germanium oxide (GeO₂).

The low-k glass composition may additionally comprise one or two or more selected from the group consisting of magnesium oxide (MgO), calcium oxide (CaO), barium oxide (BaO), and strontium oxide (SrO).

The low-k glass composition may additionally comprise one or two or more selected from the group consisting of lithium oxide (Li₂O), sodium (Na₂O), and potassium oxide (K₂O).

The low-k glass composition may further comprise one or two or more selected from the group consisting of phosphorus pentoxide (P₂O₅), titanium oxide (TiO₂), and fluorine (F₂).

The low-k glass composition may further comprise zinc oxide (ZnO), gallium oxide (Ga₂O₃), and indium oxide (In₂O₃).

The low-k glass composition may comprise 50.0 to 81.0 mol % of silica (SiO₂), 12.0 to 30.0 mol % of boron trioxide (B₂O₃), 3.0 to 15.0 mol % of aluminum oxide (Al₂O₃), 0.1 to 8.0 mol % of tellurium oxide (TeO₂), and 0.1 to 8.0 mol % of germanium oxide (GeO₂).

The low-k glass composition may have a dielectric constant of 4.9 or less and a softening temperature of 810° C. or less.

The silica (SiO₂) is an essential glass former component in forming a glass network. As a component of glass, silica (SiO₂) is an important component in forming vitrification and ensuring that the glass has thermal stability, excellent mechanical properties, and low thermal expansion properties, and that the glass has low dielectric constant and dielectric dissipation factor properties.

More specifically, if the content of the silica (SiO₂) component is too low, problems such as an increase in the dielectric constant of the glass and a decrease in the mechanical strength of the glass may occur. In addition, if the content of the silica (SiO₂) component is too high, there may be problems in that the viscosity of the glass increases, making it difficult to homogenize during the melting process, and making it difficult to produce glass fibers during the spinning process.

Therefore, in the low-k glass composition, the content of the silica (SiO₂) component is preferably in the range of 50 to 81 mol %. In order to secure the low-k glass properties and prevent the viscosity from increasing excessively, the content of the silica (SiO₂) component is more preferably in the range of 52 to 68 mol %. In order to secure the mechanical properties of the glass and facilitate molding and glass fiber spinning, the content of the silica (SiO₂) component is more preferably in the range of 54 to 62 mol %.

The boron trioxide (B₂O₃) is an important component that lowers the viscosity of glass, making the melting process of glass easier, enabling the glass fiber spinning process at low temperatures, and enabling the low-k glass composition to have a low dielectric constant and dielectric dissipation factor characteristics.

More specifically, when the content of the boron trioxide (B₂O₃) component is too low, there may be problems in that it is difficult to secure sufficiently low dielectric constant and dielectric dissipation factor characteristics, and a desired viscosity of the glass composition comprising the silica (SiO₂) increases, making melting and glass fiber spinning difficult. On the other hand, when the content of the boron trioxide (B₂O₃) component is too high, there may be problems in that the moisture resistance of the glass decreases, bubbles occur during the spinning process, the mechanical strength decreases, and the thermal expansion coefficient of the glass increases.

Therefore, in the low-k glass composition, the content of the boron trioxide (B₂O₃) component is preferably in the range of 12 to 30 mol %. In order to lower the viscosity of the glass and prevent the mechanical strength from weakening, the content of the boron trioxide (B₂O₃) component is more preferably in the range of 15 to 28 mol %. In order to sufficiently lower the viscosity of the glass and secure resistance to moisture, the content of the boron trioxide (B₂O₃) component is more preferably in the range of 18 to 27 mol %.

The aluminum oxide (Al₂O₃) is a component that acts as a glass intermediate to increase the stability of glass, facilitate vitrification, and prevent crystallization, devitrification, and phase separation of glass from easily occurring during the glass melting and glass fiber spinning processes. In addition, the aluminum oxide (Al₂O₃) can control the viscosity of glass within an appropriate range and improve the mechanical strength of glass.

More specifically, when the content of the aluminum oxide (Al₂O₃) is too low, there may be problems in that the glass stability is poor, crystallization (loss of transparency) and phase separation easily occur, and it is difficult to secure sufficient mechanical strength. On the other hand, when the content of the aluminum oxide (Al₂O₃) is too high, there may be problems in that the dielectric constant increases, the thermal stability of the glass deteriorates again, and the viscosity of the glass in a molten state becomes too high, making it difficult to spin glass fibers.

Therefore, it is preferable that the content of the aluminum oxide (Al₂O₃) component in the glass composition is in the range of 3 to 15 mol %. In order to prevent crystallization of the glass and increase in viscosity, the content of the aluminum oxide (Al₂O₃) component is more preferably in the range of 4 to 13 mol %. In order to secure the mechanical strength of the glass and prevent the dielectric constant from increasing, the content of the aluminum oxide (Al₂O₃) component is more preferably in the range of 5 to 11 mol %.

The tellurium oxide (TeO₂) used in the present invention is a component that has the function of lowering the viscosity of glass to facilitate glass fiber spinning. In addition, tellurium oxide (TeO₂) has a refining effect, and is a component that has the function of removing microbubbles generated in the glass during the glass melting process. In the prior art, substances such as As₂S₃, Sb₂O₃, and Na₂SO₄ have been used to remove microbubbles. These components have the disadvantage of being toxic or increasing the dielectric dissipation factor or dielectric constant of the glass. On the other hand, the tellurium oxide (TeO₂) according to the present invention has the effect of controlling viscosity and removing microbubbles, and simultaneously has the advantage of lowering or not significantly increasing the dielectric constant and dielectric loss. Therefore, the tellurium oxide (TeO₂) added according to the present invention can further have the effect of improving thermal and dielectric properties, as compared to glass to which tellurium oxide is not added.

Therefore, in the glass composition, the content of the tellurium oxide (TeO₂) component is preferably in the range of 0.1 to 8 mol %. In order to control viscosity and secure the effect of removing microbubbles, the content of the tellurium oxide (TeO₂) component is more preferably in the range of 0.2 to 6 mol %. In order to secure low dielectric properties and sufficient glass stability according to the composition, the content of the tellurium oxide (TeO₂) component is more preferably in the range of 0.3 to 3 mol %.

The germanium oxide (GeO₂) contained in the low-k glass composition according to one embodiment of the present invention is a component that lowers the viscosity of the glass and facilitates glass fiber spinning. In addition, germanium oxide (GeO₂) has a refining effect and can remove microbubbles generated in the glass during the glass melting process. Germanium oxide (GeO₂) has the characteristic of causing the glass to have a network structure like silica as a glass forming agent. Germanium oxide (GeO₂), a component of the oxide-based glass composition having low-k characteristics according to the present invention, has the effect of controlling the viscosity of the glass and refining the glass and simultaneously has the effect of lowering or not significantly increasing the dielectric constant and dielectric dissipation factor. Therefore, the germanium oxide (GeO₂) added according to the present invention can further have the effect of improving the thermal characteristics and dielectric characteristics, as compared to glass to which germanium oxide is not added.

Therefore, in the low-k glass composition, the content of the germanium oxide (GeO₂) component is preferably in the range of 0.1 to 8 mol %. In order to control viscosity and secure the effect of removing microbubbles, the content of the germanium oxide (GeO₂) component is more preferably in the range of 0.2 to 6 mol %. In order to secure low-k characteristics and sufficient glass stability according to the composition, the content of the germanium oxide (GeO₂) component is more preferably in the range of 0.3 to 3 mol %.

In addition, for the objectives according to the present invention, tellurium oxide and germanium oxide may be contained simultaneously in a low-k glass composition having low-k properties. In the oxide composition having the low-k properties, tellurium oxide may effectively generate a refining effect that lowers the viscosity of the glass and removes microbubbles. On the other hand, if a certain amount or more of tellurium oxide is contained in a glass composition having silica as a main component, a problem in the stability of the glass may occur depending on the composition. On the other hand, germanium oxide (GeO₂) is a glass network component having a structure similar to silica (SiO₂) and has superior glass stability, as compared to tellurium oxide. Therefore, adding tellurium oxide (TeO₂) and germanium oxide (GeO₂) simultaneously in glass may have the advantages of ensuring glass stability while exhibiting glass refining and microbubble removing effects.

Therefore, in the glass composition, the contents of the tellurium oxide (TeO₂) and germanium oxide (GeO₂) components are preferably in the ranges of 0.1 to 8 mol % and 0.1 to 8 mol %, respectively. More preferably, in order to secure thermal stability and mechanical strength of the glass according to the composition, the contents of the tellurium oxide (TeO₂) and germanium oxide (GeO₂) components may be in the ranges of 0.2 to 5 mol % and 0.2 to 5 mol %, respectively. Even more preferably, in order to secure low thermal expansion characteristics of the glass, the contents of the tellurium oxide (TeO₂) and germanium oxide (GeO₂) components may be in the ranges of 0.3 to 3 mol % and 0.3 to 3 mol %, respectively.

In addition, the glass fiber according to one embodiment of the present invention comprises the above-described low-k glass composition.

More specifically, the glass fiber according to one embodiment of the present invention may be a glass fiber prepared from a low-k glass composition comprising silica (SiO₂), boron trioxide (B₂O₃), aluminum oxide (Al₂O₃), and tellurium oxide (TeO₂).

Alternatively, the glass fiber according to one embodiment of the present invention may be a glass fiber prepared from a low-k glass composition comprising silica (SiO₂), boron trioxide (B₂O₃), aluminum oxide (Al₂O₃), and germanium oxide (GeO₂).

Alternatively, the glass fiber according to one embodiment of the present invention may be a glass fiber prepared from a low-k glass composition having glass components comprising silica (SiO₂), boron trioxide (B₂O₃), aluminum oxide (Al₂O₃), tellurium oxide (TeO₂), and germanium oxide (GeO₂).

In addition, a glass substrate according to one embodiment of the present invention comprises the above-described low-k glass composition.

More specifically, a glass substrate according to a preferred embodiment of the present invention may be a glass substrate prepared from a low-k glass composition having glass components comprising silica (SiO₂), boron trioxide (B₂O₃), aluminum oxide (Al₂O₃), and tellurium oxide (TeO₂).

Alternatively, the glass substrate according to one embodiment of the present invention may be a glass substrate prepared from a low-k glass composition having glass components comprising silica (SiO₂), boron trioxide (B₂O₃), aluminum oxide (Al₂O₃), and germanium oxide (GeO₂).

Alternatively, the glass substrate according to one embodiment of the present invention may be a glass substrate prepared from a low-k glass composition having glass components comprising silica (SiO₂), boron trioxide (B₂O₃), aluminum oxide (Al₂O₃), tellurium oxide (TeO₂), and germanium oxide (GeO₂).

Hereinafter, the present invention will be described in more detail through working examples. Each of these working examples is only one example for understanding the present invention and does not limit the scope of the present invention.

### Example 1. Preparation of Low-k Glass

Low-k glass compositions having the compositions shown in Table 1 below were prepared, and a ball mill process was performed at 150 rpm for 12 hours (hr), and then mixed and ground to prepare a mixture. The prepared mixture was heated in an electric furnace at a melting temperature of 1550 to 1650° C. for 2 to 3 hours (hr) to vitrify, thereby preparing a melt, and the melt was cast into a brass mold preheated to 650° C. and maintained near the glass transition temperature for 4 to 8 hours (hr) to relieve residual stress, and slowly cooled to room temperature (25° C.) to prepare a low-k glass.

TABLE 1

| | Components (mol %) | | | | | | | | | |
|---|---|---|---|---|---|---|---|---|---|---|
| Composition | SiO₂ | B₂O₃ | Al₂O₃ | MgO | CaO | Na₂O | ZnO | GeO₂ | TeO₂ | Remarks |
| Composition 1 | 55.0 | 27.2 | 8.0 | 1.0 | 8.0 | 0.3 | — | — | 0.5 | |
| Composition 2 | 55.0 | 27.0 | 8.0 | 1.0 | 8.0 | 0.5 | — | 0.5 | — | |
| Composition 3 | 55.0 | 27.0 | 8.0 | 1.0 | 8.0 | — | — | 0.5 | 0.5 | |
| Composition 4 | 58.0 | 22.0 | 9.0 | 1.0 | 10.0 | — | — | — | — | Comparative |
| | | | | | | | | | | example |
| Composition 5 | 58.0 | 21.0 | 9.0 | 1.0 | 10.0 | 0.5 | — | — | 0.5 | |
| Composition 6 | 58.0 | 21.0 | 9.0 | 1.0 | 10.0 | 0.5 | — | 0.5 | — | |
| Composition 7 | 62.0 | 22.0 | 6.0 | 1.0 | 6.0 | 3.0 | — | — | — | Comparative |
| | | | | | | | | | | example |
| Composition 8 | 62.0 | 22.0 | 6.0 | 1.0 | 6.0 | 3.0 | — | 0.5 | — | |
| Composition 9 | 62.0 | 22.0 | 6.0 | 1.0 | 6.0 | 3.0 | — | — | 0.5 | |
| Composition 10 | 61.0 | 22.0 | 8.0 | — | 8.0 | 1.0 | — | — | — | Comparative |
| | | | | | | | | | | example |
| Composition 11 | 61.0 | 22.0 | 8.0 | — | 8.0 | 1.0 | — | 0.5 | — | |
| Composition 12 | 61.0 | 22.0 | 8.0 | — | 8.0 | 1.0 | — | — | 0.5 | |
| Composition 13 | 64.0 | 22.0 | 4.0 | — | — | 10.0 | — | — | — | Comparative |
| | | | | | | | | | | example |
| Composition 14 | 64.0 | 22.0 | 4.0 | — | — | 9.0 | — | — | 1.0 | |
| Composition 15 | 64.0 | 22.0 | 4.0 | — | — | 9.0 | — | 1.0 | — | |
| Composition 16 | 64.0 | 22.0 | 4.0 | — | 1.0 | 9.0 | — | — | — | Comparative |
| | | | | | | | | | | example |
| Composition 17 | 64.0 | 22.0 | 4.0 | — | 1.0 | 8.0 | — | 1.0 | — | |
| Composition 18 | 64.0 | 22.0 | 4.0 | — | 1.0 | 8.0 | — | — | 1.0 | |
| Composition 19 | 64.0 | 22.0 | 4.0 | — | 1.0 | 8.5 | — | — | 0.5 | |
| Composition 20 | 64.0 | 22.0 | 4.0 | — | 1.0 | 8.0 | 0.5 | — | 0.5 | |

### Experimental Example 1

The properties of the low-k glass prepared under the conditions of Example 1 were analyzed and summarized in Table 2 below.

TABLE 2

| | CTE | Tdg | Tds | Density | Dk | Df | Dk | Df | Bubble |
|---|---|---|---|---|---|---|---|---|---|
| Composition | (ppm/° C.) | (° C.) | (° C.) | (g/cm³) | @1 GHz | @1 GHz | @28 GHz | @28 GHz | characteristics |
| Composition 1 | 4.20 | 641 | 747 | 2.311 | 4.84 | 0.0047 | 4.88 | 0.0046 | X |
| Composition 2 | — | — | — | 2.300 | 4.78 | 0.0053 | | | X |
| Composition 3 | — | — | — | 2.312 | 4.71 | 0.0025 | | | X |
| Composition 4 | — | — | — | 2.328 | 4.907 | 0.0047 | | | ◯ |
| Composition 5 | — | — | — | 2.357 | 4.908 | 0.0086 | | | X |
| Composition 6 | — | — | — | 2.349 | 4.912 | 0.0095 | | | X |
| Composition 7 | 3.89 | 613 | 729 | 2.286 | 4.735 | 0.0207 | | | ◯ |
| Composition 8 | 3.97 | 606 | 714 | 2.290 | 4.750 | 0.0203 | | | X |
| Composition 9 | 4.09 | 601 | 669 | 2.297 | 4.745 | 0.0194 | | | X |
| Composition 10 | 3.78 | 644 | 766 | 2.287 | 4.818 | 0.0093 | | | ◯ |
| Composition 11 | 3.60 | 645 | 748 | 2.297 | 4.812 | 0.0086 | | | X |
| Composition 12 | 3.89 | 632 | 750 | 2.304 | 4.801 | 0.0079 | | | X |
| Composition 13 | — | — | — | 2.258 | — | — | | | Δ |
| Composition 14 | — | — | — | 2.273 | — | — | | | X |
| Composition 15 | — | — | — | 2.263 | — | — | | | X |
| Composition 16 | 5.39 | 547 | 632 | 2.266 | 5.197 | 0.0300 | | | Δ |
| Composition 17 | — | — | — | 2.262 | — | — | | | X |
| Composition 18 | — | — | — | 2.272 | — | — | | | X |
| Composition 19 | 5.56 | 542 | 619 | 2.271 | — | — | | | X |
| omposition 20 | 5.63 | 537 | 584 | 2.276 | — | — | | | X |

In Table 2, ◯, Δ, and X, which are indicated as bubble characteristics, indicate a large number of bubbles (◯), a small number of bubbles (Δ), and almost no bubbles (X), respectively.

Referring to Table 2, the low-k glass prepared from the low-k glass composition of Composition 1 in Example 1 showed the dielectric constant and dielectric dissipation factor at 1 GHz of 4.84 and 0.0047, respectively, showing excellent dielectric properties. In addition, the low-k glass showed the dielectric constant and dielectric dissipation factor at 28 GHz of 4.88 and 0.0046, respectively, showing very excellent properties. Although the cation polarizability of tellurium (Te3+: 5.23 Å3) was significantly higher than that of silicon (Si4+: 0.87 Å3) and other glass components (Al3+: 0.79 Å3; B3+: 0.05 Å3; Ca2+: 3.16 Å3; and Mg2+ 1.32 Å3), the glass composition according to the present invention exhibited low dielectric characteristics in the bands of MHz to GHz depending on the tellurium content, which is because the glass composition according to the present invention comprises tellurium having a large ionic radius (Te4+: 0.89 Å), and, thus, the changes in oxide ion polarizability and molar volume act to reduce the dielectric constant, sufficiently offsetting the increase dielectric constant due to the cation polarizability. In addition, the glass had the softening temperature of 747° C. as analyzed by thermo-mechanical analysis (TMA) equipment, showing excellent characteristics. The glass has the advantage of having a softening temperature much lower than that of commercial low-k glass (up to 850° C.). The softening temperature being lowered by about 100° C., as compared to commercial glass, indicates that the bonding structure of the glass was changed by the addition of TeO₂, and the viscosity characteristics of the glass were greatly improved accordingly. In the case of a conventional oxide-based glass composition, the refractive index increases by the addition of tellurium. On the other hand, the glass composition according to the present invention had different characteristics in that the dielectric constant and dielectric dissipation factor in the bands of MHz to GHz were reduced by the inclusion of tellurium.

In addition, referring to Table 2, the low-k glass prepared from the low-k glass composition of Composition 2 in Example 1 had the dielectric constant and dielectric dissipation factor at 1 GHz of 4.78 and 0.0053, respectively, showing dielectric properties. Even though the germanium cation polarizability (Ge4+: 1.63 Å3) was much higher than that of silicon and other glass components, the glass exhibited low dielectric properties in the bands of MHZ to GHz by the addition of germanium because the oxide ion polarizability and molar volume changes acted to reduce the dielectric constant as germanium having a large ionic radius (Ge4+: 0.44 Å) was contained in the glass composition according to the present invention.

In addition, referring to Table 2, the low-k glass prepared from the low-k glass composition of Composition 3 in Example 1 had the dielectric constant and dielectric dissipation factor at 1 GHz of 4.71 and 0.0025, respectively, showing excellent dielectric properties. It was found that the glass composition (Composition 3) comprising both tellurium oxide and germanium oxide could induce better dielectric properties than the glass composition comprising only tellurium oxide or germanium oxide.

In addition, referring to Table 2, the low-k glass prepared from the low-k glass compositions of Compositions 5 and 6 in Example 1 was compared with the comparative example (the low-k glass prepared from the low-k glass composition of Composition 4). It was confirmed that, although Compositions 5 and 6 0.5 mol % of Na₂O, their density and dielectric constant (Dk@1 GHz) did not increase significantly, as compared to the comparative example glass that did not contain Na₂O. In addition, it was confirmed that the number of microbubbles contained in the glass was significantly reduced due to the addition of GeO₂ and TeO₂.

Also, referring to Table 2, the low-k glass prepared from the low-k glass compositions of Compositions 8 and 9 in Example 1 was compared with the comparative example (the low-k glass prepared from the low-k glass composition of Composition 7). It was confirmed that, unlike the comparative example glass, Compositions 8 and 9 containing GeO₂ and TeO₂, respectively, improved the viscosity and microbubble characteristics, and maintained the density and dielectric constant (Dk@1 GHz) at similar levels to the comparative example glass. The reason that Compositions 7 (comparative example), 8, and 9 had relatively high dielectric dissipation factor (Dk@1 GHZ=˜0.02) is because the content of Na₂O was high at 3 mol %. Therefore, it is found that too much Na₂O cannot be used to lower viscosity and secure glass stability, and that it is necessary to secure glass components and matrix composition technologies that can replace such functions.

In addition, referring to Table 2, the low-k glass prepared from the low-k glass compositions (compositions not containing MgO) of Compositions 11 and 12 in Example 1 was compared with the low-k glass prepared from the low-k glass composition of Comparative Example (Composition 10). It was confirmed that, unlike the Comparative Example glass, Compositions 11 and 12 containing GeO₂ and TeO₂, respectively, had improved viscosity and microbubble characteristics, and the dielectric constant (Dk@1 GHZ) was rather lowered, as compared to the Comparative Example glass. In addition, it was confirmed that the addition of GeO₂ and TeO₂ had the effect of slightly lowering the dielectric dissipation factor (Df@1 GHZ). The reason that Compositions 10 (Comparative Example), 11, and 12 had relatively high dielectric dissipation factors (Dk@1 GHZ=0.0079 to 0.0093) is because the content of Na₂O was high at 1 mol %. Therefore, it was found that too much Na₂O cannot be used in low-k glasses.

In addition, referring to Table 2, the low-k glass prepared from the low-k glass compositions of Compositions 14 and 15 in Example 1 (compositions containing no MgO and CaO) was compared with the low-k glass prepared from the low-k glass composition of the comparative example (Composition 13). It was confirmed that Compositions 14 and 15 containing GeO₂ and TeO₂, respectively, unlike the comparative example, had improved viscosity and microbubble characteristics and maintained the density at a similar level to that of the comparative example.

In addition, referring to Table 2, the low-k glass prepared from the low-k glass compositions of Compositions 17 and 18 (compositions containing no MgO) in Example 1 was compared with the low-k glass prepared from the low-k glass composition of the comparative example (Composition 16). It was confirmed that Compositions 17 and 18 containing GeO₂ and TeO₂, respectively, unlike the comparative example, had improved viscosity and microbubble characteristics, and maintained the density at a level lower than or similar to that of the comparative example glass.

In addition, referring to Table 2, the low-k glass prepared from the low-k glass compositions of Compositions 19 and 20 (compositions containing no MgO) in Example 1 was compared with the low-k glass prepared from the low-k glass composition of Comparative Example (Composition 16). It was confirmed that Compositions 19 and 20 containing TeO₂, unlike the comparative example, had greatly improved viscosity and microbubble characteristics, as compared to the comparative example, and that the density did not significantly increase, as compared to the comparative example glass.

In addition, it was confirmed that the glass composition prepared in Example 1 according to the present invention had sufficient thermal stability as a result of heat treatment near the liquidus temperature and the fiber forming temperature.

### Example 2. Preparation of Low-k Glass

Low-dielectric glass compositions having the compositions shown in Table 3 below were prepared, and the low-dielectric glasses were prepared using the same process as in Example 1.

TABLE 3

| | Components (mol %) | | | | | | | | | |
|---|---|---|---|---|---|---|---|---|---|---|
| Composition | SiO₂ | B₂O₃ | Al₂O₃ | MgO | CaO | Na₂O | SnO₂ | GeO₂ | TeO₂ | Remarks |
| Composition 21 | 55.00 | 27.2 | 8.0 | 1.0 | 8.0 | 0.3 | — | 0.5 | — | |
| Composition 22 | 57.00 | 25.2 | 8.0 | 1.0 | 8.0 | 0.3 | — | 0.5 | — | |
| Composition 23 | 58.60 | 22.0 | 9.0 | 1.0 | 9.0 | — | 0.4 | — | — | Comparative |
| | | | | | | | | | | example |
| Composition 24 | 58.35 | 22.0 | 9.0 | 1.0 | 9.0 | — | 0.4 | 0.25 | — | |
| Composition 25 | 58.10 | 22.0 | 9.0 | 1.0 | 9.0 | — | 0.4 | 0.5 | — | |
| Composition 26 | 57.85 | 22.0 | 9.0 | 1.0 | 9.0 | — | 0.4 | 0.75 | — | |
| Composition 27 | 57.60 | 22.0 | 9.0 | 1.0 | 9.0 | — | 0.4 | 1.0 | — | |
| Composition 28 | 57.35 | 22.0 | 9.0 | 1.0 | 9.0 | — | 0.4 | 1.25 | — | |
| Composition 29 | 57.10 | 22.0 | 9.0 | 1.0 | 9.0 | — | 0.4 | 1.5 | — | |
| Composition 30 | 58.75 | 22.0 | 9.0 | 1.0 | 9.0 | — | — | — | 0.25 | |
| Composition 31 | 58.50 | 22.0 | 9.0 | 1.0 | 9.0 | — | — | — | 0.5 | |
| Composition 32 | 58.25 | 22.0 | 9.0 | 1.0 | 9.0 | — | — | — | 0.75 | |
| Composition 33 | 58.00 | 22.0 | 9.0 | 1.0 | 9.0 | — | — | — | 1.0 | |
| Composition 34 | 58.90 | 22.0 | 9.0 | 1.0 | 9.0 | 0.1 | — | — | — | Comparative |
| | | | | | | | | | | example |
| Composition 35 | 58.80 | 22.0 | 9.0 | 1.0 | 9.0 | 0.1 | — | — | 0.1 | |
| Composition 36 | 58.70 | 22.0 | 9.0 | 1.0 | 9.0 | 0.1 | — | — | 0.2 | |
| Composition 37 | 58.30 | 22.0 | 9.0 | 1.0 | 9.0 | 0.1 | — | 0.5 | 0.1 | |
| Composition 38 | 58.20 | 22.0 | 9.0 | 1.0 | 9.0 | 0.1 | — | 0.5 | 0.2 | |
| Composition 39 | 58.50 | 22.0 | 9.0 | 1.0 | 9.0 | — | — | 0.5 | — | |
| Composition 40 | 57.50 | 22.0 | 9.0 | 1.0 | 9.0 | — | — | 1.5 | — | |

### Experimental Example 2

The properties of the low-k glass prepared under the conditions of Example 2 above were analyzed and summarized in Table 4 below.

TABLE 4

| | CTE | Tdg | Tds | Density | Dk | Df | Dk | Df | Bubble |
|---|---|---|---|---|---|---|---|---|---|
| Composition | (ppm/° C.) | (° C.) | (° C.) | (g/cm³) | @1 GHz | @1 GHz | @28 GHz | @28 GHz | characteristics |
| Composition 21 | 4.35 | 648 | 712 | 2.311 | 4.91 | 0.0051 | 4.84 | 0.00418 | X |
| Composition 22 | — | — | — | 2.325 | 4.79 | 0.0051 | | | X |
| Composition 23 | 3.57 | 704 | 799 | 2.358 | 4.89 | 0.0080 | | | Δ |
| Composition 24 | 3.53 | 681 | 788 | 2.359 | 4.88 | 0.0058 | | | X |
| Composition 25 | 3.64 | 683 | 785 | 2.366 | 4.87 | 0.0067 | | | X |
| Composition 26 | 3.83 | 680 | 785 | 2.369 | 4.86 | 0.0068 | | | X |
| Composition 27 | 3.55 | 686 | 779 | 2.372 | 4.84 | 0.0058 | | | X |
| Composition 28 | 3.75 | 683 | 776 | 2.374 | 4.83 | 0.0066 | | | X |
| Composition 29 | 3.80 | 679 | 753 | 2.380 | 4.81 | 0.0065 | | | X |
| Composition 30 | 4.02 | 669 | 781 | 2.332 | 4.85 | 0.0012 | | | X |
| Composition 31 | 4.17 | 668 | 780 | 2.337 | 4.81 | 0.0010 | | | X |
| Composition 32 | 4.03 | 664 | 774 | 2.344 | 4.77 | 0.0015 | | | X |
| Composition 33 | 3.96 | 666 | 724 | 2.351 | 4.74 | 0.0011 | | | X |
| Composition 34 | — | — | — | 2.329 | — | — | | | Δ |
| Composition 35 | 3.98 | 681 | 800 | 2.312 | — | — | | | X |
| Composition 36 | 4.01 | 675 | 794 | 2.318 | — | — | | | X |
| Composition 37 | — | — | — | 2.323 | — | — | | | X |
| Composition 38 | — | — | — | 2.323 | — | — | | | X |
| Composition 39 | — | — | — | 2.316 | — | — | | | X |
| Composition 40 | — | — | — | 2.328 | — | — | | | X |

In Table 4, ◯, Δ, and X, which are indicated as bubble characteristics, indicate a large number of bubbles (◯), a small number of bubbles (Δ), and almost no bubbles (X), respectively.

Referring to Table 4, it was confirmed that the low-k glass prepared from the low-k glass composition of Composition 21 in Example 2 had a density as low as 2.311 and the dielectric constant and dielectric dissipation factor at 1 GHz of 4.91 and 0.0051, respectively, and the dielectric constant and dielectric dissipation factor at 28 GHz of 4.84 and 0.00418, respectively, showing relatively excellent dielectric properties.

In addition, referring to Table 4, it was confirmed that the low-k glass prepared from the low-k glass composition of Composition 22 in Example 2 had a density as low as 2.325 and the dielectric constant and dielectric dissipation factor at 1 GHz of 4.79 and 0.0051, respectively, showing excellent dielectric properties.

Also, referring to Table 4, the low-k glass compositions of Compositions 24 to 29 in Example 2 were compared with the low-k glass prepared from the low-k glass composition of Comparative Example (Composition 23). As shown in Table 4, it was found that, as the GeO₂ content in Compositions 24 to 29 increased from 0.25 to 1.5 mol %, the density gradually increased from 2.359 g/cm³ to 2.380 g/cm³. On the other hand, it was confirmed that the dielectric constant (Dk@1 GHZ) gradually decreased from 4.88 to 4.81, as compared to 4.89 of the comparative example glass. In particular, the dielectric dissipation factor (Df@1 GHz) showed a lower value than that of the comparative example glass, at 0.0058 to 0.0068. These results show that GeO₂ is effective in improving the dielectric properties of glass in the band of GHz. In conventional glass compositions used for optical applications, etc., GeO₂ is used to increase the refractive index of the glass in the band of THz. In addition, when GeO₂ is contained in the conventional glass composition in the band of THz, the optical loss of the glass generally increases. On the other hand, it was found that the glass composition containing GeO₂ according to the present invention had a low dielectric constant and dielectric dissipation factor in the bands of MHz to GHz as described above, as a characteristic different from the conventional technology. In addition, it was confirmed that, as the GeO₂ content increases, the softening temperature of the glass was also lower than that of the comparative glass and continuously decreased from 788° C. to 753° C. It was found that the viscosity of the glass was lowered by adding GeO₂ to enable radiation at a relatively low temperature, thereby ensuring ease of radiation. It was confirmed that the glass also had a coefficient of thermal expansion (CTE) of 3.53 to 3.83 ppm/° C., showing very excellent characteristics.

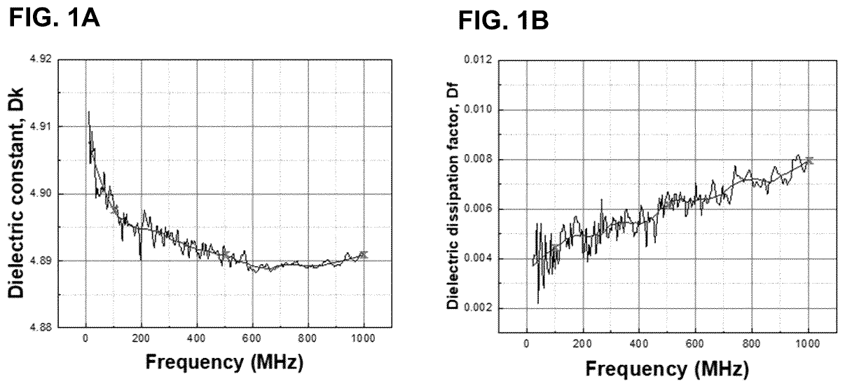

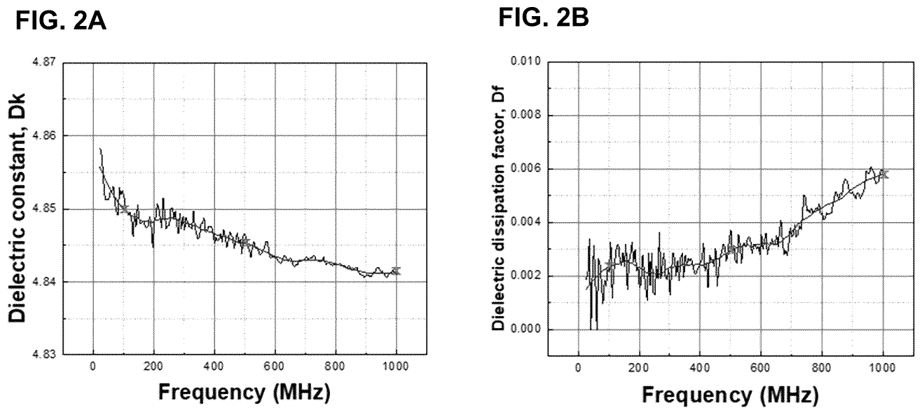

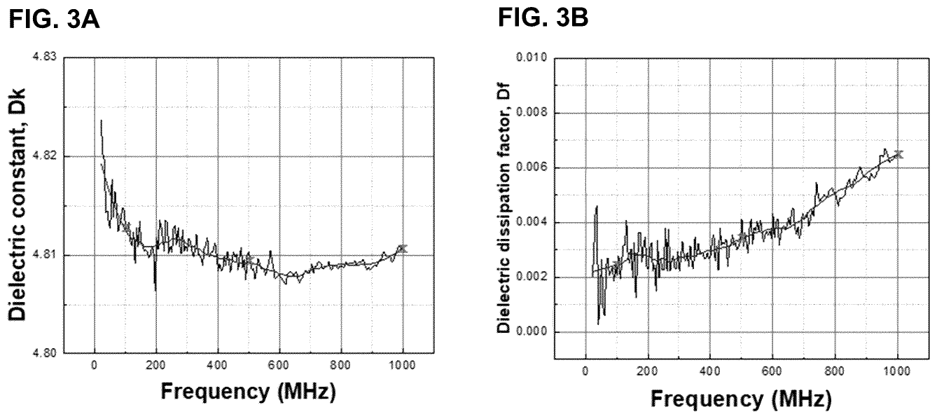

FIGS. 1A and 1B show the dielectric constant (Dk) and dielectric dissipation factor (Df) characteristics of Composition 23 (Tables 3 and 4) (Comparative Example) in Example 2 containing no GeO₂ in the bands of 10 MHz to 1 GHZ. In addition, FIGS. 2 and 3 show the dielectric constant and dielectric dissipation factor characteristics of Compositions 27 and 29 (Tables 3 and 4) of Example 2 containing 1.0 and 1.5 mol % GeO₂, respectively, in the bands of 10 MHZ to 1 GHZ according to the embodiment of the present invention. As shown in FIGS. 1 to 3, it is confirmed that the dielectric constant and dielectric dissipation factor decrease by the addition of GeO₂. The dielectric constant and dielectric dissipation factor characteristics shown in FIGS. 1 to 3 were measured by using a parallel plate method.

Also, referring to Table 4, the low-k glass prepared from the low-k glass compositions of Compositions 30 to 33 in Example 2 was compared with the low-k glass prepared from the low-k glass composition of Comparative Example (Composition 23). As shown in Table 4, it was confirmed that the density of Compositions 30 to 33 gradually increased from 2.332 g/cm³ to 2.351 g/cm³ as the TeO₂ content increased from 0.25 mol % to 1.0 mol %. On the other hand, it was confirmed that the dielectric constant (Dk@1 GHz) continuously decreased from 4.85 to 4.74, as compared to 4.89 of the comparative example glass. These results indicate that TeO₂ is effective in significantly improving the dielectric constant of glass. In particular, it was confirmed that the dielectric dissipation factor (Df@1 GHZ) was 0.0010 to 0.0015, which is significantly lower than the dielectric dissipation factor of 0.0080 of the comparative glass (composition 23). Existing glass compositions used for optical applications, etc. have characteristics in which the refractive index and optical loss increase due to the addition of TeO₂ in the band of THz. On the other hand, as a characteristic different from the existing technology, it was confirmed that the glass composition containing TeO₂ according to the present invention had a low dielectric constant and dielectric dissipation factor as described above in the bands of MHz to GHz. In addition, it was confirmed that the softening temperature was much lower than that of the comparative glass and was 781 to 724° C., which is considerably lower than that of the comparative glass containing no TeO₂, and the thermal expansion coefficient was 4.17 to 3.96 ppm/° C., which is very excellent characteristics.

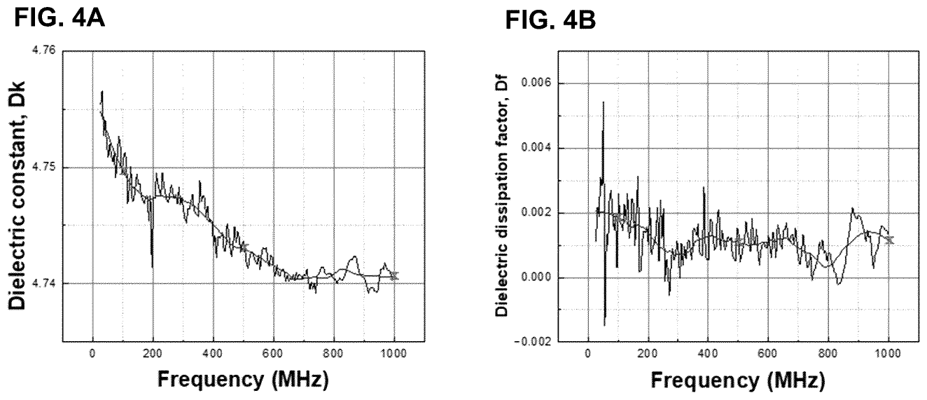

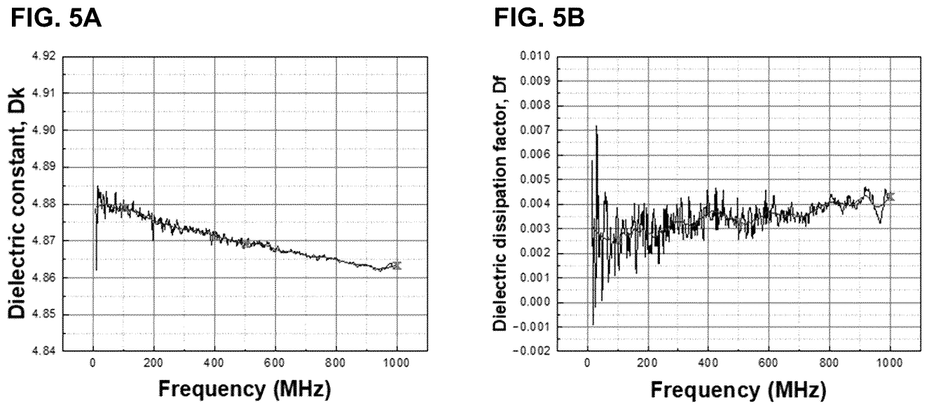

FIGS. 4A and 4B shows the dielectric constant (Dk) and dielectric dissipation factor (Df) characteristics of Glass Composition 33 (Tables 3 and 4) containing 1.0 mol % TeO₂ according to an embodiment of the present invention in the band of 10 MHz to 1 GHZ. In addition, FIGS. 5A and 5B shows the dielectric constant and dielectric dissipation factor characteristics of Glass Composition 48 (Tables 5 and 6) containing no TeO₂ according to the comparative example of the present invention in the band of 10 MHz to 1 GHZ. As shown in FIGS. 4A and 4B, it was found that the dielectric constant and dielectric dissipation factor were significantly reduced by the addition of TeO₂. The dielectric constant and dielectric dissipation factor characteristics shown in FIGS. 4A and 4B were measured by using a parallel plate method.

Also, referring to Table 4, the low-k glass prepared from the low-k glass compositions of Compositions 35 and 36 in Example 2 was compared with the low-k glass prepared from the low-k glass composition of Comparative Example (Composition 34). As shown in Table 4, the density of Compositions 35 and 36 was reduced, as compared to the Comparative Example glass when TeO₂ is contained. In addition, it was confirmed that the foam characteristics were improved, as compared to the Comparative Example glass.

Also, referring to Table 4, the low-k glass compositions of compositions 37 to 40 in Example 2 were compared with the low-k glass prepared from the low-k glass composition of Comparative Example (Composition 34). As shown in Table 4, Compositions 37 to 40 all containing GeO₂ and TeO₂ had relatively lower densities, as compared to the comparative example glass. In addition, it was confirmed that the foam characteristics were improved, as compared to the Comparative Example glass.

In addition, it was confirmed that the glass composition prepared in Example 2 according to the present invention had sufficient thermal stability as a result of heat treatment near the liquidus temperature and the fiber forming temperature.

### Experimental Example 3

In Example 2, glass having Composition 25 of Table 3 was prepared through a glass melting process, and low-k glass fibers were spun by using same at a spinning temperature of 1380° C. In a test spinning experiment, they could be spun without interruption for more than 3 hours at a spinning speed of 250 m/min, and no crystallization phenomenon occurred in the glass melt maintained at a high melting temperature for a long period of time during the spinning process.

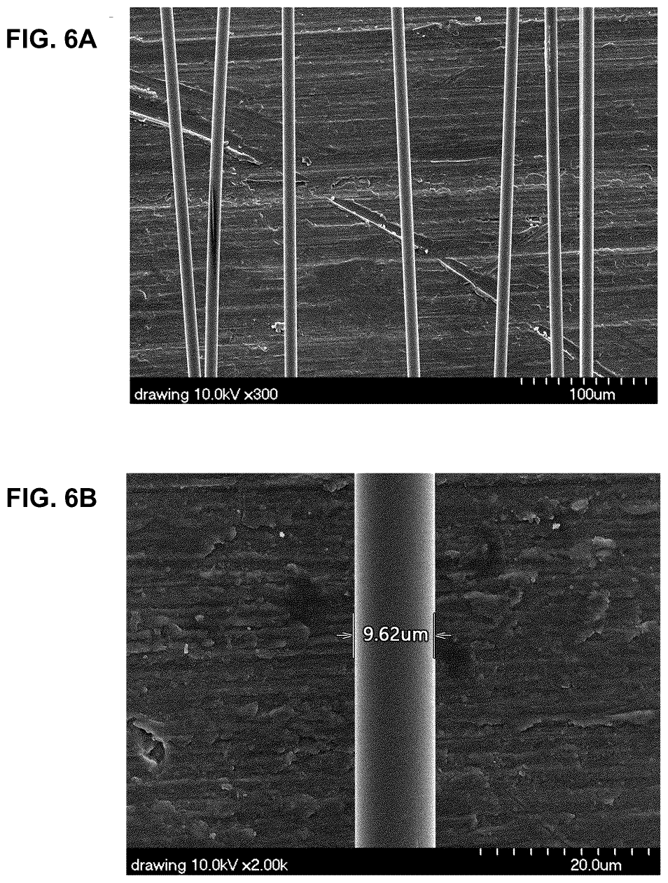

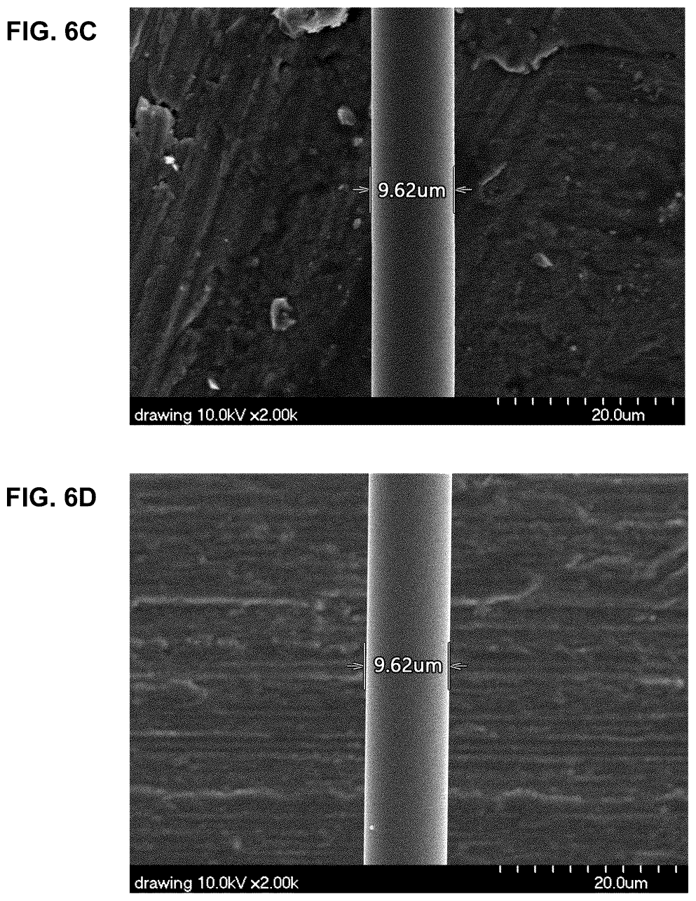

FIGS. 6A to 6D illustrate an SEM image of glass fibers radiated from the glass having Composition 25 of Table 3 in Example 2. FIG. 6A is an SEM image of glass fibers prepared by using the glass having composition 25 of Table 3 in Example 2. FIGS. 6B to 6D illustrate SEM images of different enlarged portions of FIG. 6A. Referring to FIGS. 6A to 6D, the SEM images show the conditions of a glass fiber surface having no defects. As a result of measuring the diameter of the glass fibers at various locations, it was confirmed that the diameter of the glass fibers was uniform, about 9.6 μm.

### Example 3. Preparation of Low-k Glass

A low-k glass composition having the composition shown in Table 1 below was prepared, and a ball mill process was performed at 150 rpm for 12 hours (hr), and then mixed and ground to prepare a mixture. The prepared mixture was heated in an electric furnace at a melting temperature of 1600 to 1650° C. for 2 to 3 hours (hr) to vitrify, thereby preparing a melt, and the melt was cast into a brass mold preheated to 650° C. and maintained near the glass transition temperature for 6 to 10 hours (hr) to relieve residual stress, and slowly cooled to room temperature (25° C.) to prepare a low-k glass.

TABLE 5

| | Components (mol %) | | | | | | | | | |
|---|---|---|---|---|---|---|---|---|---|---|
| Composition | SiO₂ | B₂O₃ | Al₂O₃ | MgO | CaO | Na₂O | SnO₂ | GeO₂ | TeO₂ | Remarks |
| Composition 41 | 55.0 | 28.0 | 8.0 | 1.0 | 8.0 | — | — | — | — | Comparative |
| | | | | | | | | | | example |
| Composition 42 | 57.0 | 25.5 | 8.0 | 1.0 | 8.0 | — | — | — | 0.5 | |
| Composition 43 | 59.0 | 23.5 | 8.0 | 1.0 | 8.0 | — | — | — | 0.5 | |
| Composition 44 | 59.0 | 23.2 | 8.0 | 1.0 | 8.0 | 0.3 | — | — | 0.5 | |
| Composition 45 | 68.1 | 20.6 | 4.0 | — | — | 4.3 | — | 3.0 | — | |
| Composition 46 | 68.1 | 20.6 | 4.0 | — | — | 4.3 | — | — | 3.0 | |
| Composition 47 | 57.0 | 25.5 | 8.0 | 1.0 | 8.0 | — | — | 0.5 | — | |
| Composition 48 | 59.0 | 22.0 | 9.0 | 1.0 | 9.0 | — | — | — | — | Comparative |
| | | | | | | | | | | example |
| Composition 49 | 59.0 | 22.0 | 9.0 | 0.5 | 9.0 | — | | 0.5 | — | |
| Composition 50 | 59.0 | 22.0 | 9.0 | 0.5 | 8.9 | 0.1 | | 0.5 | — | |
| Composition 51 | 59.0 | 22.0 | 9.0 | 0.5 | 8.9 | 0.1 | 0.2 | 0.5 | — | |
| Composition 52 | 59.0 | 22.0 | 9.0 | 0.5 | 8.9 | 0.1 | 0.4 | 0.5 | — | |
| Composition 53 | 60.0 | 22.0 | 9.0 | 9.0 | — | — | — | — | — | Comparative |
| | | | | | | | | | | example |
| Composition 54 | 59.0 | 22.0 | 9.0 | 9.0 | — | — | — | 1.0 | — | |
| Composition 55 | 58.0 | 22.0 | 9.0 | 9.0 | — | — | — | 2.0 | — | |
| Composition 56 | 59.5 | 22.0 | 9.0 | 3.0 | 6.0 | 0.1 | 0.4 | — | — | Comparative |
| | | | | | | | | | | example |
| Composition 57 | 58.5 | 22.0 | 9.0 | 3.0 | 6.0 | 0.1 | 0.4 | 1.0 | — | |
| Composition 58 | 57.5 | 22.0 | 9.0 | 3.0 | 6.0 | 0.1 | 0.4 | 2.0 | — | |

### Experimental Example 4

The properties of the low-k glass prepared under the conditions of Example 3 were analyzed and summarized in Table 6 below.

TABLE 6

| | | | | | | | | | |
|---|---|---|---|---|---|---|---|---|---|
| | CTE | Tdg | Tds | Density | Dk | DE | Dk | Df | Bubble |
| Composition | (ppm/° C.) | (° C.) | (° C.) | (g/cm³) | @1 GHz | @1 GHz | @28 GHz | @28 GHz | characteristics |

| | | | | | | | |
|---|---|---|---|---|---|---|---|
| Composition 41 | — | — | — | 2.338 | 5.11 | 0.0081 | ◯ |
| Composition 42 | — | — | — | 2.315 | — | — | X |
| Composition 43 | — | — | — | 2.337 | — | — | X |
| Composition 44 | — | — | — | 2.346 | — | — | X |
| Composition 45 | — | — | — | 2.177 | — | — | X |
| Composition 46 | — | — | — | 2.215 | — | — | X |
| Composition 47 | — | — | — | 2.318 | 4.775 | 0.0045 | X |
| Composition 48 | 3.94 | 679 | 788 | 2.317 | 4.863 | 0.0043 | Δ |
| Composition 49 | 3.78 | 672 | 742 | 2.339 | 4.822 | 0.0015 | X |
| Composition 50 | 4.08 | 658 | 743 | 2.356 | 4.815 | 0.0037 | X |
| Composition 51 | 3.75 | 673 | 798 | 2.366 | 4.805 | 0.0029 | X |
| Composition 52 | 3.46 | 715 | 793 | 2.371 | 4.806 | 0.0011 | X |
| Composition 53 | — | — | — | 2.297 | — | — | ◯ |
| Composition 54 | — | — | — | 2.294 | — | — | X |
| Composition 55 | — | — | — | 2.288 | — | — | X |
| Composition 56 | — | — | — | 2.303 | 4.690 | 0.0034 | Δ |
| Composition 57 | — | — | — | 2.323 | 4.605 | 0.0014 | X |
| Composition 58 | — | — | — | 2.346 | 4.536 | 0.0015 | X |

In Table 6, ◯, Δ, and X, which are indicated as bubble characteristics, indicate a large number of bubbles (◯), a small number of bubbles (Δ), and almost no bubbles (X), respectively.

In Table 5, Composition 41 is a comparative glass composition for Compositions 1 to 3 in Example 1. Referring to Table 6, the dielectric constant at 1 GHZ of the glass prepared from comparative example Composition 41 was 5.11, and the dielectric dissipation factor was 0.0081, which shows that, despite not containing Na₂O, the glass had higher dielectric constant and dielectric dissipation factor characteristics than the glasses prepared by adding TeO₂ and GeO₂ according to the present invention in Compositions 1 to 3.

In addition, referring to Table 6, it was confirmed that Compositions 42 to 44, when containing TeO₂ according to the present invention, had improved microbubble characteristics, as compared to the comparative example (Composition 41), and the density was lower than or maintained at a similar level to the comparative example glass.

In addition, referring to Table 6, it was confirmed that Compositions 45 and 46, unlike the comparative example (composition 16), contained GeO₂ and TeO₂, respectively, thereby improving the microbubble characteristics and significantly lowering the density than the comparative example glass.

In addition, referring to Table 6, it was confirmed that Composition 47 had a lower density than Composition 22, and that the dielectric constant and dielectric dissipation factor at 1 GHz were 4.775 and 0.0045, respectively, which were improved, as compared to Composition 22.

In addition, referring to Table 6, it was confirmed that Compositions 49 to 52, unlike the comparative example (Composition 48), contained GeO₂ as shown in Table 6, thereby showing a slightly increased density and significantly lower dielectric constant and dielectric dissipation factor, as compared to the comparative example glass. In addition, it was confirmed that the foam characteristics are improved, as compared to the comparative example glass.

In addition, referring to Table 6, it was confirmed that Compositions 54 and 55, unlike the comparative example (Composition 53), contained GeO₂ according to the present invention as shown in Table 6, thereby showing a reduced density, as compared to the comparative example glass. In addition, it was confirmed that the foam characteristics are greatly improved, as compared to the comparative example glass.

In addition, referring to Table 6, it was confirmed that Compositions 57 and 58, unlike the comparative example (composition 56), contained GeO₂ according to the present invention as shown in Table 6, thereby having a somewhat increased density and the foam characteristics were improved, as compared to the comparative example glass.

In addition, it was confirmed that the glass composition prepared in Example 3 according to the present invention had sufficient thermal stability as a result of heat treatment near the liquidus temperature and the fiber forming temperature.

### Experimental Example 5

Recently, PCB technology that is easy to integrate and scale up is in demand. To achieve this, it is necessary to be able to implement a fine redistribution layer (RDL) and LS value. As compared to CCL-based PCB materials, glass substrates have excellent thermal characteristics, less warping, excellent flatness, and similar physical properties to silicon, which is a semiconductor material, thereby making it easy to create microstructures using etching processes, etc., and, thus, high-performance PCBs can be easily manufactured.

By using Compositions 1 and 2 in Example 1 above, a glass substrate was prepared as follows.

### Experimental Example 5-1. Preparation of Glass Substrate Having Composition 1

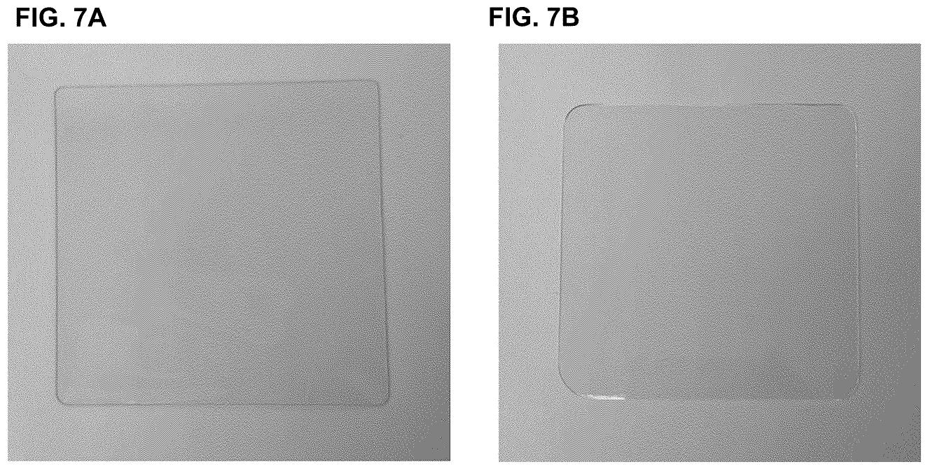

A low-k composition according to Composition 1 (Table 1, containing 0.5 mol % of TeO₂) in Example 1 was prepared as a raw material, subjected to a ball mill process at 150 rpm for 12 hours (hr), and mixed and grounded to prepare a mixture. The prepared mixture was heated in an electric furnace at a melting temperature of 1550° C. for 3 hours (hr) to vitrify, thereby preparing a melt, and the glass melt was poured into a brass mold preheated to 670° C., and the glass melt was quickly pressed by using a brass cover preheated to the same temperature (670° C.). Then, the glass was maintained near the glass transition temperature for 5 hours (hr) to relieve residual stress, and slowly cooled to room temperature (25° C.) to prepare a low-k glass substrate. A photographic image of the prepared glass substrate is shown in FIG. 7A. Referring to FIG. 7A, it was confirmed that a glass substrate having a thickness of 200 μm, a smooth surface, excellent flatness, and no microbubbles was prepared by a glass melting and pressing process.

### Experimental Example 5-2. Preparation of Glass Substrate Having Composition 2

A low-k composition according to Composition 2 in Example 1 (Table 1, containing 0.5 mol % of GeO₂) was prepared as a raw material, subjected to a ball mill process at 50 rpm for 12 hours (hr), and mixed and grounded through to prepare a mixture. The prepared mixture was heated in an electric furnace at a melting temperature of 1550° C. for 3 hours (hr) to vitrify, thereby preparing a melt, and the glass melt was poured into a brass mold preheated to 670° C., and the glass melt was quickly pressed by using a brass cover preheated to the same temperature (670° C.). Then, the glass was maintained near the glass transition temperature for 5 hours (hr) to relieve residual stress, and slowly cooled to room temperature (25° C.) to prepare a low-k glass substrate. A photographic image of the prepared glass substrate is shown in FIG. 7B. Referring to FIG. 7B, it was confirmed that a glass substrate having a thickness of 250 μm, a smooth surface, and no microbubbles was prepared by a glass melting and pressing process.

In FIGS. 7A and 7B, a low-k glass substrate containing TeO₂ (FIG. 7A) and GeO₂ (FIG. 7B) was prepared by a pressing process according to the present invention. However, it can be prepared by using various processes such as an extrusion process using a preheated roller, a floating process, and a fusion process.

### Example 4. Preparation of Low-k Glass

Low-dielectric glass compositions having the compositions shown in Table 7 below were prepared, and the low-dielectric glasses were prepared by using the same process as in Example 3.

TABLE 7

| | Components (mol %) | | | | | | | | | | | | | | | |
|---|---|---|---|---|---|---|---|---|---|---|---|---|---|---|---|---|
| Composition | SiO₂ | B₂O₃ | Al₂O₃ | MgO | CaO | Na₂O | P₂O₅ | TiO₂ | F₂ | ZnO | Ga₂O₃ | In₂O₃ | SnO₂ | GeO₂ | TeO₂ | Remarks |
| Co. 59 | 58 | 22 | 9 | 1 | 9 | 0.1 | 0.1 | | | | | | 0.3 | — | 0.5 | |
| Co. 60 | 61 | 22 | 6 | 1 | 9 | 0.1 | | 0.1 | | | | | 0.3 | — | 0.5 | |
| Co. 61 | 64 | 22 | 3 | 1 | 9 | 0.1 | | | 0.1 | | | | 0.3 | — | 0.5 | |
| Co. 62 | 66 | 22 | 1 | 1 | 9 | 0.1 | | | | 0.1 | | | 0.3 | — | 0.5 | |
| Co. 63 | 55.9 | 22 | 9 | 1 | 9 | 0.1 | | | | | | | — | — | 3 | |
| Co. 64 | 52.9 | 22 | 9 | 1 | 9 | 0.1 | | | | | | | — | — | 6 | |
| Co. 65 | 48.9 | 22 | 9 | 1 | 9 | 0.1 | | | | | | | — | — | 10 | |
| Co. 66 | 50 | 29.9 | 9 | 1 | 9 | 0.1 | | | | | 0.1 | | 0.4 | 0.5 | — | |
| Co. 67 | 58 | 22 | 9 | 1 | 9 | 0.1 | | | | | | | 0.4 | 0.5 | — | |
| Co. 68 | 68 | 11.9 | 9 | 1 | 9 | 0.1 | | | | | | 0.1 | 0.4 | 0.5 | — | |
| Co. 69 | 50 | 30 | 9 | 1 | 9 | 0.1 | | | | 0.1 | | | 0.3 | — | 0.5 | |
| Co. 70 | 58 | 22 | 9 | 1 | 9 | 0.1 | | | | | 0.1 | | 0.3 | — | 0.5 | |
| Co. 71 | 68 | 12 | 9 | 1 | 9 | 0.1 | | | | | | 0.1 | 0.3 | — | 0.5 | |
| Co. 72 | 55 | 22 | 11.8 | 1 | 9 | 0.1 | 0.1 | | | 0.1 | | | 0.4 | — | 0.5 | |
| Co. 73 | 52 | 22 | 14.8 | 1 | 9 | 0.1 | | 0.1 | | 0.1 | | | 0.4 | — | 0.5 | |
| Co. 74 | 64 | 22 | 3 | 1 | 9 | 0.1 | | | | | | | 0.4 | 0.5 | — | |
| Co. 75 | 58 | 22 | 9 | 1 | 9 | 0.1 | | | | | | | 0.4 | 0.5 | — | |
| Co. 76 | 52 | 22 | 15 | 1 | 9 | 0.1 | | | | | | | 0.4 | 0.5 | — | |
| Co. 77 | 59.8 | 21 | 9 | 1 | 9 | 0.1 | | | | | | | — | 0.1 | — | |
| Co. 78 | 52.9 | 22 | 9 | 1 | 9 | 0.1 | | | | | | | — | 6 | — | |
| Co. 79 | 48.9 | 22 | 9 | 1 | 9 | 0.1 | | | | | | | — | 10 | — | |
| Co. 80 | 52.8 | 20 | 9 | 1 | 9 | 0.1 | | | | | | | — | 0.1 | 8 | |
| Co. 81 | 52.8 | 20 | 9 | 1 | 9 | 0.1 | | | | | | | — | 8 | 0.1 | |
| Co. 82 | 52.9 | 20 | 9 | 1 | 9 | 0.1 | | | | | | | — | 4 | 4 | |
| Co. 83 | 59.4 | 22 | 9 | 9 | — | 0.1 | | | | | | | 0.4 | 0.1 | — | |
| Co. 84 | 58.8 | 22 | 9 | 1 | 9 | — | | | | | | | 0.2 | 1 | — | Comparative |
| | | | | | | | | | | | | | | | | example |
| Co. 85 | 58.55 | 22 | 9 | 1 | 9 | — | | | | | | | 0.2 | 0.25 | — | |
| Co. 86 | 58.3 | 22 | 9 | 1 | 9 | — | | | | | | | 0.2 | 0.5 | — | |
| Co. 87 | 58.05 | 22 | 9 | 1 | 9 | — | | | | | | | 0.2 | 0.75 | — | |
| Co. 88 | 57.8 | 22 | 9 | 1 | 9 | — | | | | | | | 0.2 | 1 | — | |
| Co. 89 | 57.55 | 22 | 9 | 1 | 9 | — | | | | | | | 0.2 | 1.25 | — | |
| Co. 90 | 57.3 | 22 | 9 | 1 | 9 | — | | | | | | | 0.2 | 1.5 | — | |

### Experimental Example 6

The properties of the low-k glass prepared under the conditions of Example 4 above were analyzed and summarized in Table 8 below.

TABLE 8

| | | | | | Dk | Df |
|---|---|---|---|---|---|---|
| | CTE | Tdg | Tds | Density | @1 | @1 |
| Composition | (ppm/° C.) | (° C.) | (° C.) | (g/cm³) | GHz | GHz |
| Composition 59 | — | — | — | 2.333 | <4.9 | — |
| Composition 60 | — | — | — | 2.324 | <4.9 | — |
| Composition 61 | — | — | — | 2.301 | <4.9 | — |
| Composition 62 | — | — | — | 2.287 | <4.9 | — |
| Composition 63 | — | — | — | 2.390 | <4.9 | — |
| Composition 64 | — | — | — | 2.409 | <4.9 | — |
| Composition 65 | — | — | — | 2.426 | <4.9 | — |
| Composition 66 | — | — | — | 2.334 | <4.9 | — |
| Composition 67 | — | — | — | 2.333 | <4.9 | — |
| Composition 68 | — | — | — | 2.358 | <4.9 | — |
| Composition 69 | — | — | — | 2.344 | <4.9 | — |
| Composition 70 | — | — | — | 2.343 | <4.9 | — |
| Composition 71 | — | — | — | 2.368 | <4.9 | — |
| Composition 72 | — | — | — | 2.356 | <4.9 | — |
| Composition 73 | — | — | — | 2.378 | <4.9 | — |
| Composition 74 | — | — | — | 2.298 | <4.9 | — |
| Composition 75 | — | — | — | 2.354 | <4.9 | — |
| Composition 76 | — | — | — | 2.366 | <4.9 | — |
| Composition 77 | 4.03 | 684 | 810 | 2.310 | <4.9 | — |
| Composition 78 | — | — | — | 2.385 | <4.9 | — |
| Composition 79 | — | — | — | 2.402 | <4.9 | — |
| Composition 80 | — | — | — | 2.391 | <4.9 | — |
| Composition 81 | — | — | — | 2.376 | <4.9 | — |
| Composition 82 | 3.99 | 668 | 790 | 2.382 | <4.9 | — |
| Composition 83 | — | — | — | 2.285 | 4.43 | 0.0012 |
| Composition 84 | 3.55 | 666 | 756 | 2.327 | 4.87 | 0.0041 |
| Composition 85 | 3.52 | 665 | 738 | 2.331 | 4.85 | 0.0030 |
| Composition 86 | 3.58 | 665 | 743 | 2.332 | 4.83 | 0.0030 |
| Composition 87 | 3.51 | 665 | 755 | 2.335 | 4.80 | 0.0028 |
| Composition 88 | 3.43 | 665 | 749 | 2.340 | 4.78 | 0.0026 |
| Composition 89 | 3.64 | 665 | 755 | 2.344 | 4.74 | 0.0026 |
| Composition 90 | 3.77 | 663 | 742 | 2.347 | 4.71 | 0.0025 |

Tables 7 and 8 show the compositions and properties of low-k glass compositions containing additional components according to the present invention as additional working examples and experimental examples. It was confirmed that the dielectric properties of the glass were improved and sufficient viscosity and microbubble properties were secured depending on the addition of tellurium oxide and germanium oxide. In particular, as shown in Compositions 84 to 90, as compared to the comparative glass composition (Table 8, Composition 84), when the germanium oxide component increased from 0.25 mol % to 1.5 mol %, the dielectric constant continuously decreased and the dielectric dissipation factor also continuously improved, and the dielectric constant and dielectric dissipation factor at 1 GHz were 4.71 and 0.0025, respectively, which were very excellent properties.

In the working examples shown in Tables 7 and 8, phosphorus pentoxide (P₂O₅), titanium oxide (TiO₂), and fluorine (F₂) are components that have the effect of additionally improving the viscosity of the glass. However, if used excessively, they may interfere with the thermal stability of the glass and, thus, are preferably used within 0.05 to 5 mol %. Zinc oxide (ZnO), gallium oxide (Ga₂O₃), and indium oxide (In₂O₃) are components that have the function of preventing devitrification of the glass and improving the thermal stability. However, if used excessively, they may rather interfere with the thermal stability of the glass and increase the dielectric constant and, thus, are preferably used within 0.1 to 3 mol %. In addition, alkaline components such as lithium oxide (Li₂O), sodium oxide (Na₂O), and potassium oxide (K₂O) may be used to lower the viscosity of the glass and simultaneously improve the thermal stability of the glass. However, if used excessively, they may cause problems of increased dielectric constant and dielectric dissipation factor and, thus, are preferably used within 0.05 to 1.5 mol %.

### Example 5. Preparation of Low-k Glass

Low-dielectric glass compositions having the compositions shown in Table 9 below were prepared, and the low-dielectric glasses were prepared by using the same process as in Example 3. Some compositions with high SiO₂ content had slightly elevated melting temperatures in the range of 1650 to 1750° C.

TABLE 9

| | Components (mol %) | | | | | | | | | | | | | | | |
|---|---|---|---|---|---|---|---|---|---|---|---|---|---|---|---|---|
| Composition | SiO₂ | B₂O₃ | Al₂O₃ | MgO | CaO | Na₂O | P₂O₅ | TiO₂ | F₂ | ZnO | Ga₂O₃ | In₂O₃ | SnO₂ | GeO₂ | TeO₂ | Remarks |

| | | | | | | | | | |
|---|---|---|---|---|---|---|---|---|---|
| Composition 91 | 58.50 | 22.0 | 9.0 | 3.0 | 6.0 | 0.1 | 0.4 | 1.0 | |
| Composition 92 | 57.50 | 22.0 | 9.0 | 3.0 | 6.0 | 0.1 | 0.4 | 2.0 | |
| Composition 93 | 56.50 | 22.0 | 9.0 | 3.0 | 6.0 | 0.1 | 0.4 | 3.0 | |
| Composition 94 | 55.50 | 22.0 | 9.0 | 3.0 | 6.0 | 0.1 | 0.4 | 4.0 | |
| Composition 95 | 72.00 | 12.0 | 3.0 | 3 | 7.5 | 0.5 | | 2.0 | |
| Composition 96 | 76.00 | 12.0 | 3.0 | 2 | 4.5 | 0.5 | | 2.0 | |
| Composition 97 | 80.00 | 12.0 | 3.0 | 1 | 1.5 | 0.5 | | 2.0 | |
| Composition 98 | 81.00 | 12.0 | 3.0 | 1 | 0.5 | 0.5 | | 2.0 | |
| Composition 99 | 80.00 | 12.0 | 3.0 | 1 | 1.5 | 0.5 | | | 2.0 |
| Composition 100 | 81.00 | 12.0 | 3.0 | 1 | 0.5 | 0.5 | | | 2.0 |

### Experimental Example 7

The properties of the low-k glass prepared under the conditions of Example 5 above were analyzed and summarized in Table 10 below.

TABLE 10

| | CTE | Tdg | Tds | Density | Dk | DE | Dk | Df | Foam |
|---|---|---|---|---|---|---|---|---|---|
| Composition | ppm/° C.) | (° C.) | (° C.) | (g/cm³) | @1 GHz | @1 GHz | @28 GHz | @28 GHz | characteristic |
| Composition 91 | 3.71 | 672 | 761 | 2.323 | 4.62 | 0.0034 | 4.62 | 0.0037 | X |
| Composition 92 | 3.92 | 672 | 760 | 2.346 | 4.54 | 0.0033 | — | — | X |
| Composition 93 | 2.72 | 667 | 774 | 2.357 | 4.49 | 0.0029 | 4.70 | 0.0038 | X |
| Composition 94 | 3.83 | 670 | 778 | 2.366 | 4.46 | 0.0026 | — | — | X |
| Composition 95 | 3.53 | — | — | 2.302 | 4.42 | 0.0031 | — | — | X |
| Composition 96 | 3.50 | — | — | 2.291 | 4.41 | 0.0027 | — | — | X |
| Composition 97 | 3.48 | — | — | 2.273 | 4.39 | 0.0028 | — | — | X |
| Composition 98 | 3.46 | — | — | 2.252 | 4.37 | 0.0024 | — | — | X |
| Composition 99 | 3.81 | — | — | 2.251 | 4.33 | 0.0023 | — | — | X |
| Composition 100 | 3.78 | — | — | 2.333 | 4.29 | 0.0021 | — | — | X |

Tables 9 and 10 show the compositions and physical properties of low-k glass compositions containing additional components according to the present invention as additional examples and experimental examples. It was confirmed that the properties of the glass were improved and dielectric sufficient viscosity and microbubble properties were secured according to the addition of germanium oxide. As can be seen in Compositions 91 to 93, when the content of the germanium oxide component increased from 1.00 mol % to 4.0 mol %, it was confirmed that the dielectric constant at 1 GHz continuously decreased from 4.62 to 4.46, and the dielectric dissipation factor at 1 GHz also continuously improved to 0.0026, which was very excellent characteristics.

In addition, as can be seen in Compositions 95 to 98, when the germanium oxide component was contained at 2.0 mol %, the content of the SiO₂ component was increased to 81.0 mol %, and the combined content of the Cao and MgO components was lowered to 10 mol % or less, it was confirmed that the dielectric constant continuously decreased to 4.37, and the dielectric dissipation factor exhibited very excellent characteristics in the range of 0.0031 to 0.0024. In addition, it was confirmed that the glasses having Compositions 99 and 100 to which tellurium oxide was added had very low dielectric characteristics and excellent microbubble characteristics. When the SiO₂ component was contained at a high concentration of up to 81 mol % and the tellurium oxide component was contained at 2 mol, it was confirmed that the 1 GHz dielectric constant at 1 GHz was lowered to 4.29, and the dielectric dissipation factor at 1 GHz was also lowered to 0.0021.

In another working example, when, in glass compositions similar to Compositions 95 to 98, containing both germanium oxide and tellurium oxide components, the SiO₂ component was increased to 81.00 mol % and the combined content of Cao and MgO components was adjusted to 10 mol % or less, it was confirmed that the compositions had a low dielectric constant of 4.50 or less and a low dielectric dissipation factor of 0.0030 or less.

As described above, the present invention has been described with reference to the illustrative drawings, but the present invention is not limited to the embodiments and drawings disclosed herein, and it is obvious that various modifications may be made by those skilled in the art within the scope of the technical idea of the present invention.

What is claimed is:

1. A low-k glass composition comprising:
silica (SiO₂); boron trioxide (B₂O₃); aluminum oxide (Al₂O₃); and tellurium oxide (TeO₂).

2. The low-k glass composition of claim 1,
wherein the composition additionally comprises one or two or more selected from the group consisting of magnesium oxide (MgO), calcium oxide (CaO), barium oxide (BaO), and strontium oxide (SrO).

3. The low-k glass composition of claim 1,
wherein the composition additionally comprises one or two or more selected from the group consisting of lithium oxide (Li₂O), sodium (Na₂O), and potassium oxide (K₂O).

4. The low-k glass composition of claim 1,
wherein the composition additionally comprises one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

5. The low-k glass composition of claim 1,
wherein the composition comprises 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of tellurium oxide (TeO₂).

6. The low-k glass composition of claim 1,
wherein the composition has a dielectric constant of 4.9 or less and a softening temperature of 810° C. or less.

7. A low-k glass composition comprising:
silica (SiO₂); boron trioxide (B₂O₃); aluminum oxide (Al₂O₃); and germanium oxide (GeO₂).

8. The low-k glass composition of claim 7,
wherein the composition additionally comprises one or two or more selected from the group consisting of magnesium oxide (MgO), calcium oxide (CaO), barium oxide (Ba), and strontium oxide (SrO).

9. The low-k glass composition of claim 7,
wherein the composition additionally comprises one or two or more selected from the group consisting of lithium oxide (Li₂O), sodium (Na₂O), and potassium oxide (K₂O).

10. The low-k glass composition of claim 7,
wherein the composition additionally comprises one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

11. The low-k glass composition of claim 7,
wherein the composition comprises 50.0 to 81.0 mol % of silica (SiO₂), 12.0 to 30.0 mol % of boron trioxide (B₂O₃), 3.0 to 15.0 mol % of aluminum oxide (Al₂O₃), and 0.1 to 10.0 mol % of germanium oxide (GeO₂).

12. The low-k glass composition of claim 7,
wherein the composition has a dielectric constant of 4.9 or less and a softening temperature of 810° C. or less.

13. A low-k glass composition comprising:
silica (SiO₂); boron trioxide (B₂O₃); aluminum oxide (Al₂O₃); tellurium oxide (TeO₂); and germanium oxide (GeO₂).

14. The low-k glass composition of claim 13,
wherein the composition additionally comprises one or two or more selected from the group consisting of magnesium oxide (MgO), calcium oxide (CaO), barium oxide (BaO), and strontium oxide (SrO).

15. The low-k glass composition of claim 13,
wherein the composition additionally comprises one or two or more selected from the group consisting of lithium oxide (Li₂O), sodium (Na₂O), and potassium oxide (K₂O).

16. The low-k glass composition of claim 13,
wherein the composition additionally comprises one or two or more selected from the group consisting of phosphorus pentoxide (P₂O₅), titanium oxide (TiO₂), fluorine (F₂), zinc oxide (ZnO), gallium oxide (Ga₂O₃), and indium oxide (In₂O₃).

17. The low-k glass composition of claim 13,
wherein the composition comprises 50.0 to 81.0 mol % of silica (SiO₂), 12.0 to 30.0 mol % of boron trioxide (B₂O₃), 3.0 to 15.0 mol % of aluminum oxide (Al₂O₃), 0.1 to 8.0 mol % of tellurium oxide (TeO₂), and 0.1 to 8.0 mol % of germanium oxide (GeO₂).

18. The low-k glass composition of claim 13,
wherein the composition has a dielectric constant of 4.9 or less and a softening temperature of 810° C. or less.

19. A glass fiber comprising the low-k glass composition of claim 1.

20. A glass fiber comprising the low-k glass composition of claim 7.

21. A glass fiber comprising the low-k glass composition of claim 13.

22. A glass substrate comprising the low-k glass] composition of claim 1.

23. A glass substrate comprising the low-k glass composition of claim 7.

24. A glass substrate comprising the low-k glass composition of claim 13.
